(19) United States
(12) Patent Application Publication
(10) Pub. No.: US 2018/0191079 A1
(43) Pub. Date: Jul. 5, 2018

(54) INDOOR POSITIONING SYSTEM UTILIZING BEAMFORMING WITH ORIENTATION- AND POLARIZATION-INDEPENDENT ANTENNAS

(71) Applicant: AMI Research & Development, LLC, Windham, NH (US)

(72) Inventors: John T. Apostolos, Lyndeborough, NH (US); William Mouyos, Windham, NH (US); James D. Logan, Candia, NH (US); Sean Joseph, Windham, NH (US)

(21) Appl. No.: 15/861,739

(22) Filed: Jan. 4, 2018

Related U.S. Application Data
(60) Provisional application No. 62/442,102, filed on Jan. 4, 2017.
(60) Provisional application No. 62/454,178, filed on Feb. 3, 2017.

(51) Int. Cl. H01Q 19/13; H01Q 25/00; H01Q 9/16

(52) U.S. Cl. CPC H01Q 19/136; G01S 5/0247; H01Q 9/16; H01Q 25/001

(57) ABSTRACT

Orientation-independent antennas and associated beamforming circuits, to provide polarization-independent determination of position. An Indoor Positioning System (IPS) may utilize beacon or tag devices equipped with orientation-independent antennas to determine the location of nearby objects. The system can exist in many different customizable configurations, sometimes utilizing orientation-independent antennas embedded in smartphones that serve as beacon or tag devices. The devices, systems and methods described herein may be used for an IPS in a residential setting, a commercial setting (like a department store), an event or workplace, or an industrial setting.

### CROSS REFERENCE TO RELATED APPLICATIONS

This application claims priority to a co-pending U.S. Provisional patent application entitled “Indoor Positioning System Utilizing Beamforming with Orientation- and Polarization-Independent Antenna”, Ser. No. 62/442,102 filed Jan. 4, 2017, and Indoor Positioning System Utilizing Beamforming With Orientation- And Polarization-Independent Antennas. Ser. No. 62/454,178 filed Feb. 3, 2017 the entire contents of both of which are hereby incorporated by reference.

### BACKGROUND

Recent advances in indoor location and positioning technologies have leveraged the growing ubiquity of smartphones. One application involves tracking the in-store movements of customers in retail stores and shopping malls using Near Field Communication (NFC), ibeacons, GPS and other technologies. Another application of these technologies is in tracking the location of objects within other areas, such as a private home or office, where inexpensive tags are used to track easily misplaced objects.

These systems tend to make use of WiFi, Bluetooth, and other radio receivers to derive position information. However, other sensors such as gyroscopes, inclinometers and accelerometers that tend to be included in many smartphones have also been used for motion detection.

### SUMMARY

Techniques for geolocation are described that use orientation-independent antennas and associated beamforming circuits that provide polarization-independent determination of location. Indoor Positioning System (IPS) applications are newly enabled and/or improved.

Techniques for geolocation are also described that use orientation-independent antennas and associated beamforming circuits that provide polarization-independent determination of location. Indoor Positioning System (IPS) applications are newly enabled and/or improved. In particular, a ceiling-mounted orientation-independent antenna can determine azimuth and elevation and thus pinpoint the location of a mobile device in three dimensions.

Knowledge of the geometry of the facility assists with resolving ambiguities that might otherwise exist when the mobile device is out of a direct line of sight. Calibration runs, using devices with a known location, can then be used to resolve these ambiguities.

### BRIEF DESCRIPTION OF THE DRAWINGS

The description below refers to the accompanying drawings, of which:

FIG. 1 illustrates an Indoor Positioning System;

FIGS. 2A-2E are different implementations of orientation-independent antennas;

FIG. 3 is a set of reference axes in 3D space;

FIG. 4 is an example beamforming circuit to provide angle of arrival;

FIG. 5 is an alternate arrangement for an orientation-independent antenna;

FIG. 6 is a beamformer used with the orientation-independent antenna of FIG. 5; and

FIG. 7 shows additional steps to obtain azimuth and elevation.

FIG. 8 is a representation of a department store floor and illustrates an Indoor Positioning System using the orientation-independent antenna array.

### DETAILED DESCRIPTION OF AN ILLUSTRATIVE EMBODIMENT

### Indoor Positioning System (IPS) Using Orientation-Independent Antennas

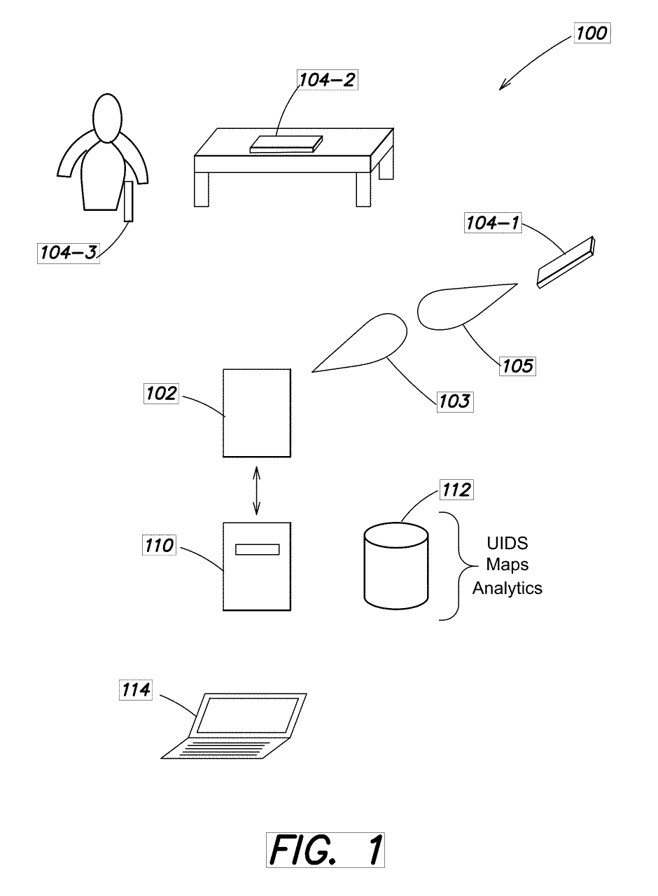

FIG. 1 illustrates a location and/or positioning system 100 which includes a “beacon” device 102 and a number of “tags” 104-1, 104-2, 104-3. The beacon 102 and tags 104 may take several forms. For example, in an application of the system 100 for a retail store, the beacon 102 may be part of or include a wireless hub, and the tags 104 may be smartphones used by customers who are shopping in the store. In another application of the system 100 for tracking personal items such as within a home, the beacon device 102 may be a smartphone or it may be a hub, or it may be incorporated in is a device such as an Amazon™, Alexa™, or Google Home™. Tags 104 may be inexpensive radio repeaters attached to items to be tracked such as a set of keys, a wallet, a pet, etc. Tags 104 may also be more complex devices such as smartphones having a wide range of processing capabilities and user interfaces such as touchscreens, or something in-between in terms of complexity such as some other wireless Internet-connected thing. The beacon 102 and tags 104 may communicate with one another using Bluetooth, WiFi, or specialized radio frequencies and protocols dedicated to indoor location and/or positioning functions.

The beacon 102 may in turn be connected via wireless or wired connection to a processor 110 that accesses one or more databases 112. The databases may derive and/or maintain information such as unique identification (UID) numbers for the tags 104 or their associated users, maps of the location in which the system 100 is placed, and other information such as analytics derived from collected location data. The databases 112 may be accessed by other devices 114 such as a laptop computer to display and analyze the data collected by system 100. Processor 110 and databases 112 may be partially or wholly contained within beacon 102.

Of note is that beacon 102 and/or tags 104 include scanning directional antennas that may focus radiate energy in steerable beams 103, 105. The use of scanning directional antennas enables the distance between the beacon 102 and tags 104 to be increased as compared to implementations that instead use fixed omnidirectional antennas. It should also be noted that the tags 104 and their respective antennas may be disposed in various orientations with respect to the surrounding area. For example, tag 104-2 is laying horizontally on a table, but tag 104-3 is attached to an object in a person's pocket, and is laying in a generally vertical direction. Tag 104-1 is in some other location, such as in a person's hand, and is thus positioned at some other unknown angle.

The use of directional antennas also increase security of system 100 as interference from unknown devices 102, 104 may be attenuated.

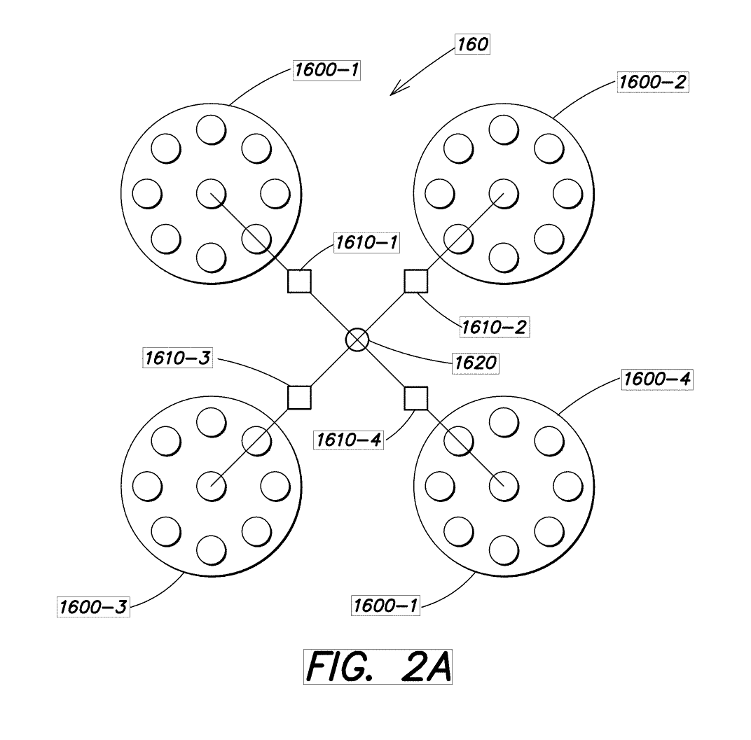

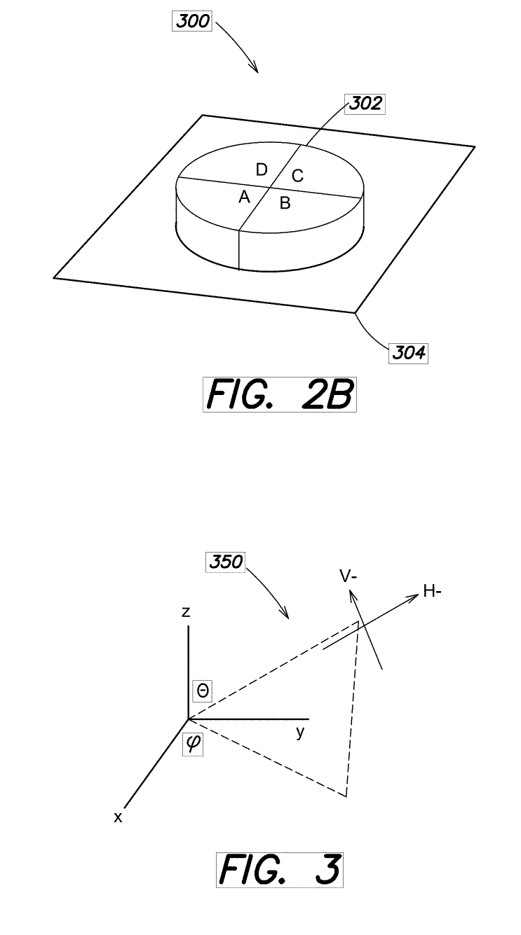

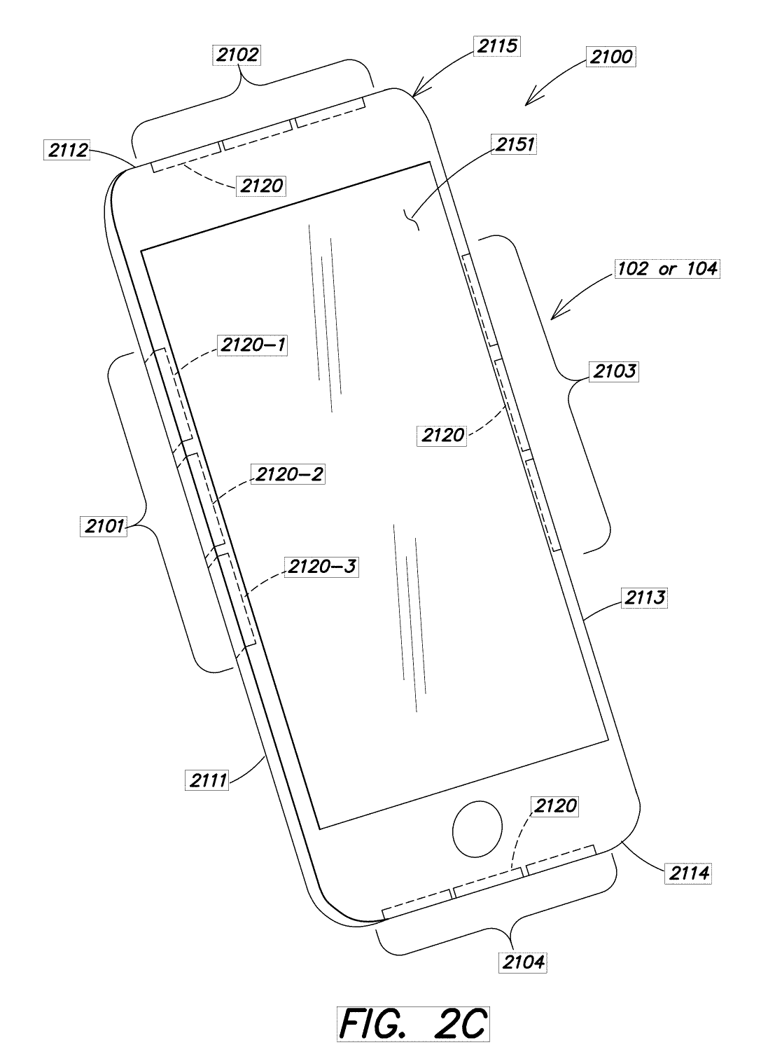

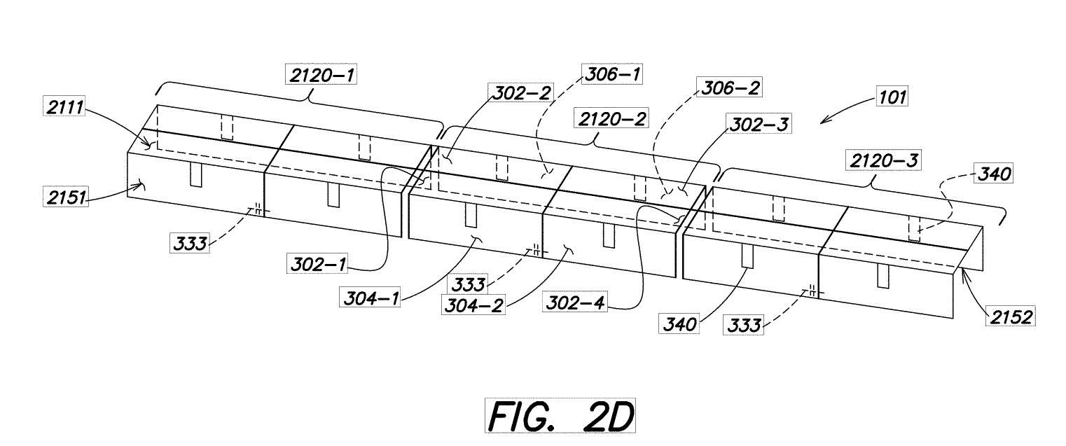

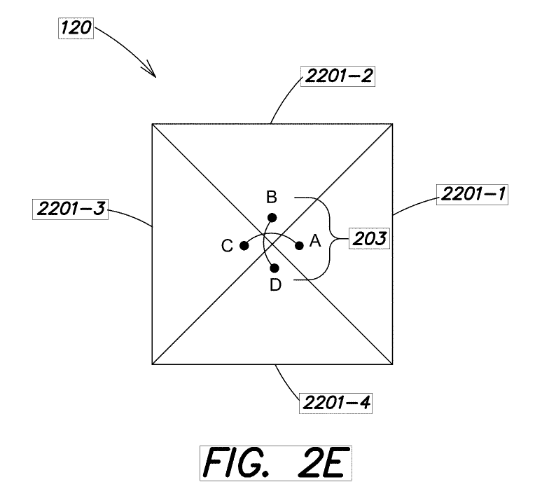

FIG. 2 is one implementation for a directional, orientation-independent antenna which may be used in the beacon device 102. This orientation-independent antenna 160 consists of one or more subarrays 1600-1, 1600-2, 1600-3, 1600-4. Each subarray includes a number of cylindrical radiating elements with a center driven element surrounded by two or more parasitic or driven elements arranged in a circle about the center element. The elements may be controlled to provide different polarizations or beamforming. Each of the individual cylindrical elements may include a set of quadrant sections that provide a pair of crossed dipoles as shown in FIG. 2B. The center elements from each of the subarrays 1600-1, 1600-2, 1600-3, 1600-4 may be connected to a common feed 1620 through respective delays 1610-1, 1610-2, 1610-3, and 1610-4. The delay elements 1610 may be software controlled (such as by controller, not shown) to provide further beamforming. This type of cylindrical, (orientation-independent steerable antenna array is described in further detail in issued U.S. Pat. Nos. 9,118,116 and 8,988,303, and co-pending U.S. patent application Ser. No. 15/362,988 filed Nov. 29, 2016, and U.S. Patent Application 62/432,973 filed Dec. 12, 2016, all of which are assigned to AMI Research and Development, LLC and which are all hereby incorporated by reference.

FIG. 2B is one example implementation for a steerable, directional antenna 300 used in the tags 104. It consists of a single volumetric cylindrical element 302 disposed over a ground plane 304. The cylindrical element 302 used in this implementation also consists of a set of quadrant sections A,B,C,D.

FIG. 2C is another implementation of an orientation-independent directional antenna array disposed within a wireless device 2100 which may be a beacon 102 or tag 104. The wireless device 2100 may include a rectangular housing with a front face, a back face, and four sides or edges. The device may be of the familiar “bar” form factor such as an Apple™ iPhone™ or Android™ smartphone. Along the four sides of the housing are is placed one or more volumetric antenna elements 2120. In one configuration, a set of three volumetric antenna elements are connected as arrays 2101, 2102, 2103, 2104 disposed along or near each of the four sides 2111, 2112, 2113, 2114. The volumetric elements 2120 may each circumscribe a three-dimensional space. In this design, the volumetric elements may each be a planar, conductive, material patch. The conductive material patch may be of a size, for example, to operate efficiently at Fourth-Generation (4G) wireless frequencies.

The radiating elements 2120 may have various physical configurations and may be tuned in particular ways. For example, rectangular patch elements may be folded over onto or near the front and back faces in a “u” shape to conform to the edges of housing 2115. In that configuration, the radiating elements circumscribe a volume that not only encompasses a space along the edge of the housing, but also encompasses a space that reaches into the body of the device 2100.

In some arrangements as shown in FIG. 2D, the elements 2120 may each be a pair of crossed dipoles, or even two or more pairs of crossed dipoles. Here each element 2120 may be an orientation-independent antenna radiator consisting of a pair of crossed dipoles formed from four patch radiators. Here each of the four patches 302-1, 302-2, 3021-3 and 3021-4 in an example element 2120-2 is metal surface disposed on an insulating (dielectric) substrate. Feed points may be connected in an A,C and B,D pair to provide the pair of crossed dipoles, similar to the FIG. 2B embodiment, as shown in FIG. 2E. As explained in the co-pending patent applications referenced above, the crossed dipoles may be further coupled to combining circuit(s) that can selectively provide different polarizations. Circular, horizontal, and/or vertical polarizations may be provided by selectable feed networks.

The X,Y,Z axes shown in FIG. 3 next to example antenna element 300 represent the surrounding three dimensional space, with the ground plane 304 parallel to the X-Y plane. (Although element 300 is a cylindrical dipole pair per the FIGS. 2A and 2B embodiment, the same or similar X, Y, Z axis arrangement pertain to the folded over dipoles of FIGS. 2C-2E.) A signal of interest 350 may radiate from or to a direction defined by an azimuth angle phi (φ) and elevation angle theta (θ). The signal of interest may have both horizontal (H−) and vertical (V−) polarization components, but the antenna 300 and corresponding beamforming components exhibit orientation independent operation with both horizontal (H−) and vertical (V−) polarizations present in a signal of interest.

In one aspect, the horizontal component H may be suppressed by the cylindrical antenna element 300 if the diameter versus height ratio of the cylinder 302 is relatively large. In one example for operation at 2400 MHz, bandwidth of 200 MHz, a quality factor Q of 12 in a FIG. 2A or 2B embodiment, the volumetric cylinder 302 has a diameter of 0.81 inches and a height of 0.16 inches.

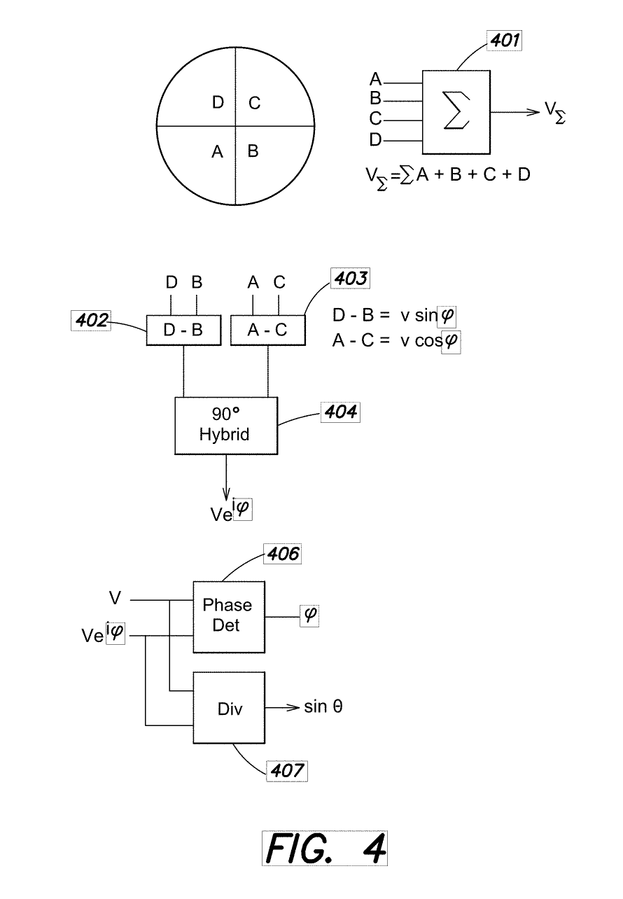

FIG. 4 illustrates a Radio Frequency (RF) beamforming circuit that can be used to produce an orientation independent response from antenna 300 that determines both the azimuth and elevation angles. In this arrangement, a first hybrid combiner 401 produces a signal V_{Σ} representing the sum of signals at the four elements A, B, C, D and, with the suppression of the horizontal component, represents only (or mostly) the vertical component.

A second hybrid power combiner 402, which is a difference, or 180° combiner provides an output signal

D−B=ν sin(φ)

and a third 180° hybrid 403 provides

A−C=ν cos(φ)

The outputs of combiners 402, 403 feed a 90° quadrature hybrid 404 to produce a signal,

V=νe^{jφ}

proportional to the azimuthal angle.

A phase detector 406 can determine a phase difference 406 between signals V_{Σ} and V thus provides the azimuthal angle, φ. A hybrid divider 407 determines the ratio between them, to produce an output proportional to the elevation angle θ.

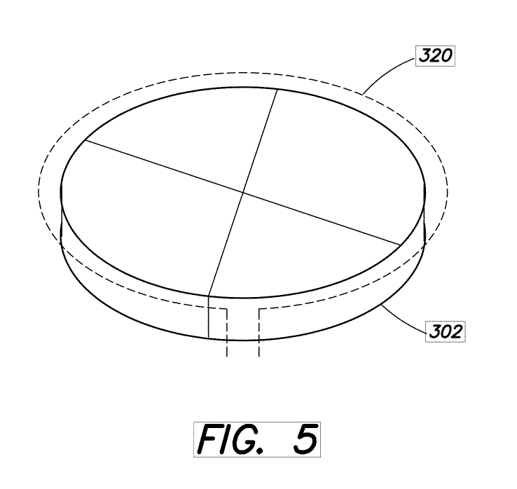

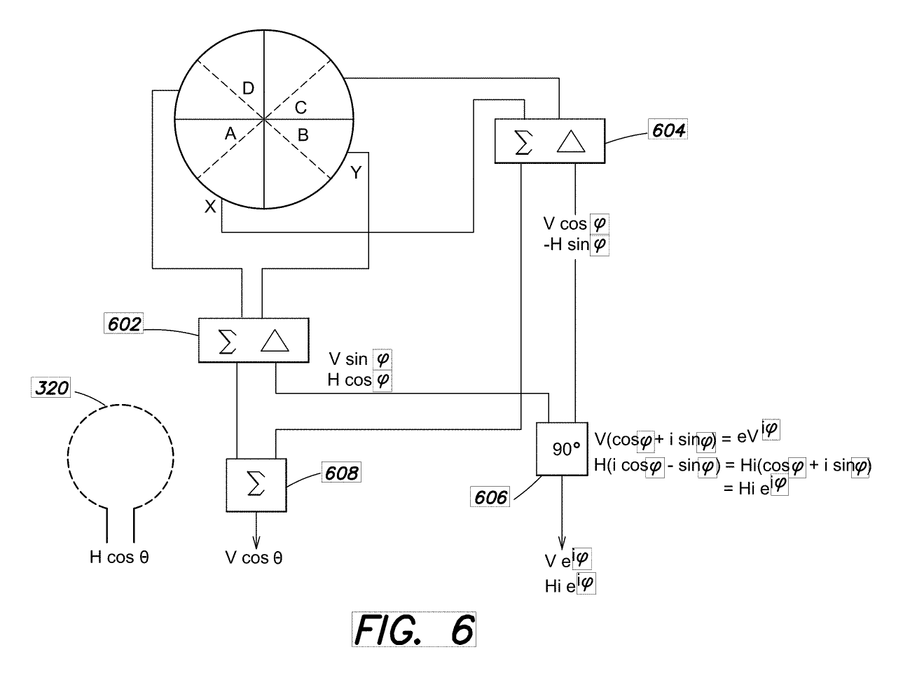

Another implementation shown in FIG. 5 can be used where both horizontal and vertical polarization are present. A circular wire loop 320 is disposed above the cylindrical element 300. As shown in FIG. 6, the output of the wire loop 320 can be combined with other signals to produce a signal proportional to the horizontal component

H cos θ

Hybrid combiners 602, 604 are 180° combiners that provide both a sum and difference output. The 180° hybrid combiners 602, 604, quadrature combiner 606, and combiner 608, arranged as shown, produce signals:

V cos θ

V sin φ

H cos φ

H sin φ

Ve^{jφ}

and

He^{iφ}

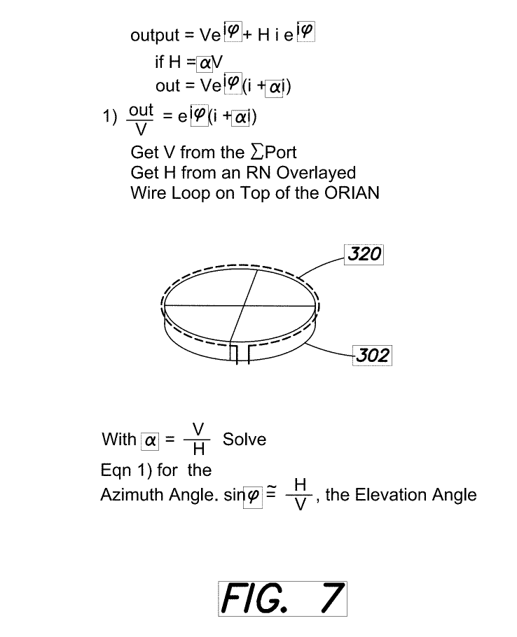

As shown in the equations of FIG. 7, the resulting signals from the hybrid combiners can be further processed to obtain signals representative of both the azimuth and elevation that are independent of any horizontal component and vertical component. For example, Analog-to-Digital Converter(s) (ADCs) may process the outputs of the hybrid combiners and be fed to one or more Digital Signal Processors (DSPs) to perform one or more of the method steps of FIG. 7, thus obtaining an azimuth and elevation.

In one implementation, the tags 104 may be smartphones. In that implementation, as per FIGS. 2C and 2D, the orientation-independent antenna may include four sets of super directive end fire line arrays of volumetric patch antennas disposed around the respective sides of the smartphone housing. Such an antenna array is capable of high accuracy angle of arrival and range measurements.

It can now be understood that both types of orientation-independent antenna arrays—the cylindrical element arrays shown in FIG. 1, and the end fire line arrays shown in FIGS. 2C and 2D—can be used to estimate an angle of arrival of received signals. In one configuration, this is done by initially scanning through the available beam directions (e.g., 2111 and 2113) in both azimuth and elevation with an accuracy of between about 45 and 90 degrees. A subsequent scan can be made with higher accuracy through selective beamforming of the array elements, once the initial estimate of position is made.

In one use case, the detected angle of arrival happens to be parallel to two of the sides of the smartphone housing (“due north” or “due south”), or happens to coincide with a centerline axis of the cylindrical array implementation. In that instance, the two sets of beams generated by the line arrays on the two sides that are parallel to that direction (that is, line arrays 2101 and 2103 shown in FIG. 2C) may be used in an interferometer mode to obtain a more accurate estimate of an angle of arrival. Similarly for the cylindrical array case, two sets of beams may be generated by combinations of selected cylindrical element outputs aligned with the direction of arrival. The expected accuracy for a signal to noise ratio of 20 dB is about 0.1 degrees if the spacing of the two line arrays 2101, 2103 is about one wavelength apart. The resulting narrow beams can enable stereoscopic direction finding or a “triangulation” mode, which enables another is way to estimate range.

### Indoor Positioning System Options and Use Cases

The functions described above are obtained by packing an orientation-independent antenna or some other similar antenna in a single device to provide position and/or direction finding.

### Scanning Rates:

In some implementations, the antenna array 160 associated with the beacon 102 may be scanned at a rate that is different than the rate at which the antenna 300 associated with the tag 104 is scanned. Different procedures may be used to determine which device scans at the higher rate, while the other device scans or is incrementally stepped at a slower rate.

### Inclinometer Alignments to Directional Array:

An inclinometer, if available in the beacon 102 or tag 104, may provide some additional information as to the orientation of the X, Y, and Z axes with respect to a reference, such as the earth's magnetic field. That information may be used to simplify the processing needed to determine elevation and azimuth.

### Ranging Techniques

The distance between beacon 102 and tag 104 may be determined by any known ranging techniques. In one example, range can be determined using time difference of arrival (TDOA) using a cooperative protocol that places the tag 104 in a transponder mode, and having the beacon 102 emit a narrow ranging pulse (on the order of a few nanoseconds wide). The range can then be estimated by measuring the delay of the resulting response from the tag 104. Other methods are possible, for example, if the cellular, WiFi, Bluetooth, or other wireless protocols in use provide Receive Signal Strength Indication (RSSI) outputs.

In other implementations, the beacon 102 and tag 104 may not necessarily operate a cooperative ranging protocol. In that instance, range may still be determined by operating individual circular subarrays 1600 of array 160 or end fire arrays 2101, etc. in a stereoscopic or triangulation mode. For example, a first circular subarray 1600-1 may be placed in a scanning mode and locate a first angle of arrival φ1 for a tag 104. A second circular subarray 1600-2 may also be placed in a scanning mode—because subarray 1600-2 is at a slightly different position, it may detect a signal from tag 104 at a second angle of arrival φ2. A crossover point between line vectors φ1 and φ2 determines a location for tag 104.

Thus, in one implementation, for tags 104 operating a cooperative protocol, the beacon 102 may selectively use the directional forwarding/time of flight mode to determine position. However, for tags 104 that do not operate a cooperative protocol, the beacon may switch to a mode that uses stereoscopy/triangulation to locate the tags 104.

### A Single Orientation-Independent Antenna Tag:

A single orientation-independent antenna tag 104 may actively scan for neighboring beacons 102 using its directional capabilities. This scanning will incur approximately 5% more energy consumption to do than to simply broadcast omni-directionally like most traditional Bluetooth low energy systems do. The orientation-independent antenna beamforming directional scanning region may be focused in the direction it is scanning, and thus have a relatively narrow, or pencil beam shape. This directional scanning may, for example, have approximately 25% more range than an omni-directional scan, allowing for more active positioning to take place, and reducing interference.

In some implementations, the orientation-independent antennas 160, 300 or 2100 may scan quadrant by quadrant in 45 degree or 90 degree intervals. Upon coming into contact with an orientation-independent antenna array (a beacon 102) or another orientation-independent antenna equipped device 104, such as a smartphone, the orientation-independent antenna tag 104 and the new signal may both orient themselves through scanning to maximize signal strength between the two. At this point the orientation-independent antenna's position relative to the new signal may be determined to within about 1% by the smartphone or beacon using time of flight, signal strength, and/or directional information stored by the orientation-independent antenna from an inclinometer. This relative location can either be used directly by an orientation-independent antenna equipped smartphone user (with an arrow pointing in the direction stating the distance away the object is) or can be converted to absolute positional data by the beacon. Assuming the building has been mapped in some way or another and the beacons location in the building has been tied to that map, the absolute location of that orientation-independent antenna can be determined, not just its location relative to the beacon/smartphone signal. These capabilities come at a low cost to manufacture. In some implementations, the orientation-independent antenna can operate at a unique frequency using a unique waveform so it does not interfere with other signals such as Bluetooth, Wi-Fi, or other signals.

### Multiple Orientation-Independent Antenna Tags:

A similar process my occur with multiple orientation-independent antenna tags 104 as for a single orientation-independent antenna tag 104; they may come into contact with one another while scanning and form a constellation of relative positions by communicating between themselves. Once one of those relative positions is tied to an absolute location by a beacon 102 or orientation-independent antenna equipped smartphone, all of the other relative locations in contact with the absolute orientation-independent antenna may also be resolved to absolute locations using the same process.

### Beacons:

As shown in FIG. 1, beacons 102 can comprise an orientation-independent antenna array, a processor 110, and a connection to local or cloud-based database 112. The orientation-independent antenna array works to locate signals from other orientation-independent antennas 104 or traditional Bluetooth devices or traditional Wi-Fi devices within the beacon's range. There are several advantages to using the orientation-independent antenna beacon. Because of its extended range, a single orientation-independent antenna beacon 102 is capable of determining the location of nearby orientation-independent antennas, Bluetooth devices, and Wi-Fi signals. This is in contrast to many other beacon based systems which may require multiple beacons to properly determine location for an area of a given size. This location information can be utilized in different ways. As explained above, the orientation-independent antennas in the beacon 102 can be used with beamforming to determine the location of non-orientation-independent antenna Bluetooth signals. Scanning can also occur with higher resolution, allowing for finer directional adjustment while scanning.

### Orientation-Independent Antenna in a Smart Device:

An orientation-independent antenna embedded in a smart mobile device (smartphone or laptop) works largely the same as an orientation-independent antenna tag 104, but unlike most orientation-independent antenna embedded tags (like a TV remote or a keychain), a smart device is capable of giving feedback directly to the user. This means when an orientation-independent antenna embedded smart device enters an orientation-independent antenna “constellation” it can give the user information about the objects nearby it. A map could be displayed, marked with waypoints (like pins on a map) for orientation-independent antenna objects and labeled based off of a Unique Identification (UID). Additionally, when no predefined map is readily available, the orientation-independent antenna smart device can act as a sort of compass, pointing the phone in the direction of the orientation-independent antenna objects and giving the user angle and distance information.

### Orientation-Independent Antenna Adjustment Based Off of Previous Smartphone or Beacon Interactions:

If an orientation-independent antenna equipped device 102, 104 frequently makes connections with smart devices or beacons in a specific direction, the devices may alter their scanning pattern(s) in order to intelligently scan areas where it is more likely to pick up a signal. This means if an object is in one corner of a home (for example), and a beacon 102 only ever finds connections by pointing west, it will spend far more of its time searching in that direction, making it even easier to detect tags 104.

### Intelligent Scanning Rates:

One design consideration for an orientation-independent antenna-based IPS system is the directional scanning rate of each orientation-independent antenna equipped object 102, 104. If two objects scan around themselves at the exact same rate it is possible they may never come into contact with each other even if they are within range. To counteract this issue, orientation-independent antenna scanning rates may be variable. Low energy objects such as tags 104 with small batteries may scan at a slow rate. Beacons 102 could scan at a much higher rate (and with more smooth adjustments rather than scanning quadrant by quadrant) because of their energy source (a wall plug). Smart devices (such as a phone or laptop) using orientation-independent antennas may also utilize a variable scan rate. The smartphone orientation-independent antenna may scan at a higher rate than tags 104, similar to a beacon, however such a smart device may scan at a lower rate than the beacon 102 itself to allow nearby beacons to improve detection.

### Usage of IPS System in Various Settings:

### Residential Setting

In a residential setting the orientation-independent antenna can be used as an object detection apparatus for other orientation-independent antenna equipped objects throughout the house. A single stationary orientation-independent antenna equipped device with access to an electrical outlet (a beacon 102) or a smartphone equipped with an orientation-independent antenna may be sufficient in order to locate any object within their range. The beacon or smartphone are not necessarily doing the actual mapping of the house, as this could be accomplished by one of the various home mapping technologies currently available. However, mapping could also be completed by using a stationary orientation-independent antenna device in tandem with a smartphone.

1. Stationary Orientation-Independent Antenna with Access to Wall Outlet:
One of these residential beacon orientation-independent antennas 102 could be placed somewhere in the house. Embedded in an Amazon™ Alexa™ or Google Home™ or similar devices would be one preferred option. This orientation-independent antenna device could give information regarding the location of other orientation-independent antenna equipped devices in the house. In the example of an Amazon™ Alexa™ the user could ask “where are the car keys” and the Alexa™ could respond with “in the living room”. One additional feature to this residential setup is that a map of the home could be utilized to bind the constellation of orientation-independent antenna devices 104 (generated as the devices in the house come into contact with one another and each determine their relative location, as described previously) to the physical world. This could be a picture of a floor plan, a map generated by currently available home mapping technology, a map generated by the user as a drawing, or a map generated using other orientation-independent antenna devices and a smartphone equipped with an orientation-independent antenna.

2. Using a Mobile Device with an Orientation-Independent Antenna:
In a home without an orientation-independent antenna beacon 102 but with orientation-independent antenna tags 104, location data could still be used by an orientation-independent antenna equipped smartphone. The phone may detect nearby orientation-independent antenna equipped devices and create a constellation map of these for the user. This information might still be relative positional data, but because the user would be holding the orientation-independent antenna equipped phone, they could still use the constellation around them to find the object they want. Essentially, because the smartphone user knows where they themselves are and they know the relative position (distance and angle) of the nearby orientation-independent antennas, they can tie the orientation-independent antenna constellation to the familiar real world position of the devices around them.

3. Using Both to Map the House:
When a user has access to both an orientation-independent antenna equipped beacon 102 and an orientation-independent antenna equipped mobile device 104 the user can create a map of the house. This map would help tie the relative location of the orientation-independent antenna device constellation to the real world position of those objects in the house. This process would be initiated by the user on the smartphone. They would start at the entrance to the home and pace the perimeter of the house. Because the orientation-independent antenna beacon 102 is stationary and can track orientation-independent antenna tags or mobile device(s) 104, the user may create an outline of their home. Additionally software could be implemented to label the various rooms of this user created map, allowing for even greater ease in locating orientation-independent antenna tags 104 in the house.

4. on the go:
Even when in a car or out in the world an orientation-independent antenna equipped system can still work as a limited IPS system. For example; assume a user drives their car out for a picnic. The user then forgets their keys in the field where they had the picnic. The user backtracks to near where they believe they lost their keys and tries to locate them using an orientation-independent antenna equipped smartphone. If the keys have an orientation-independent antenna tag in the chain and are within range the phone can tell the user the distance and angle the keys are from the user. This can be used as a sort of compass directing the user back to their keys. This system can also be used to make sure a user doesn't lose their keys in the first place. The keys and phone could be set to notify the user if they become a certain range apart from one another.

### Commercial Setting

In a Commercial setting the orientation-independent antenna equipped devices may be used in an indoor mapping system in order to determine positional data. A single stationary orientation-independent antenna beacon may be all that is necessary for positional tracking as long as all objects that need to be tracked are within its range. There are various different ways the orientation-independent antenna based IPS can be used in a commercial setting. The beacon 102 can be used to track materials throughout a store. The beacon 102 can also track orientation-independent antenna equipped mobile devices 104 moving throughout its range. The beacon can even track non cooperative sources such as non-orientation-independent antenna equipped Bluetooth devices using its ranging techniques described elsewhere. This permutation of the IPS could also tie very closely into available mapping software. One conceivable use of this could be a user with a shopping list. Assuming the objects are tagged when the user enters the store, an app like Google™ maps could be overlaid with collected data to create an optimum path to get to all of the objects on their list as quickly as possible. Additionally, if the objects are tagged the user could be charged directly through their phone when they leave the store without having to check out.

1. Beacon and Orientation-Independent Antenna Based Smartphone (and Orientation-Independent Antenna Equipped Objects):
When a beacon 102 is in a store it can track the location of all smart device users with orientation-independent antennas 104 within the range of the beacon through the previously described methods. This can be used to communicate with the orientation-independent antenna mobile devices 104 so users can determine their own location within a store. For example, in a shopping mall a user could find their precise location within the mall by checking their phone rather than having to find a mall map kiosk. This map the users are presented with can be used as an advertising space for stores as well. Users could see what stores are nearby and receive recommendations for what is on sale right on the map. This system could also work in a single store like a Home Depot™. The user could be told by the beacon their own position in the store and also see waypoints (like a pin on a map) of objects within the store equipped with orientation-independent antennas. This could be used as a searchable catalog so that a user could simply “Google maps search,” for example, “duct tape” in the store and be presented with a pin on the map of the store for the aisle and bay location of the duct tape. This could work as additional ad space with specific tape manufacturers purchasing advertisement(s) for their stocked brand to show up as the users first search result.

2. Beacon and Non-Cooperating Bluetooth or Other Signals:
For big-data and consumer-trends purposes data could also be collected from consumers not trying to utilize the orientation-independent antenna indoor positioning system. If a store owner installed a beacon 102 even if no users were interested in connecting with the orientation-independent antenna indoor positioning system, some data could be recorded. For example, standard Bluetooth or WiFi signals transmitted by a phone may be positionally tracked by orientation-independent antenna beacons 102 through the use of stereoscopy. This data could be used by store owners in order to optimize the experience of consumers in the store. This could be done by opening more registers in response to the number of people in the store or determining superior aisle structuring based off of consumer movement data.

3. Beacon and Cooperating Legacy Devices (Like Bluetooth):
Assuming a user was interested in connecting with the indoor positioning system, they could use the system even if their device wasn't equipped with an orientation-independent antenna. In one example, as long as they allow a Bluetooth connection with the beacon 102 they could be given exact positional data from the beacon. This information could be collected by the beacon as described in the previous scenario and the user can be identified by their Bluetooth UID. The user could then indicate they were in the store and interested in using the IPS (by opening the app) and the app would connect their positional data to them.

### Event Setting

In an event setting like a trade show or an amusement park, the orientation-independent antenna based IPS is also useful. The system would function somewhat similarly to how it functions in a commercial setting; with a beacon 102 set up somewhere at the event and users 104 being tracked. The additional functionality for events could be using orientation-independent antenna tags 104 to create waypoints for certain booths or rides. Being able to look at an interactive park/event map on a smartphone would also give the opportunity to present users with more advertisements for specific booths, rides, or events the event would like to promote by annotating the map. In a theme-park like environment, the IPS would also make a great child tracker. Many child devices have GPS capabilities so parents can roughly keep track of their child's location, but in a setting like an amusement park, those rough GPS-based estimates may not be accurate enough if a child goes missing. Being able to precisely keep track of a child's position using the IPS can be achieved with the parent and child device once they have allowed their devices to be visible to one another on the map through permissions. A child would not even necessarily need to have a smartphone, but may only need an inexpensive orientation-independent antenna tag 104 set up to only transmit positional data to the parent/user device. This would be sufficient to keep track of child's position without revealing it to strangers.

### Industrial Setting

In an industrial setting such as a warehouse or system of warehouses there are already many different types of package tracking systems. An orientation-independent antenna based positioning system can work similarly to other package tracking systems, or build off of them, while also offering the additional functionality of displaying the packages as waypoints or pins on a map for employees. Many automated systems have a drawback of being difficult to navigate for humans. Robots can find packages just fine, but if an issue pops up, a human needs to look through a database of countless packages to find it. By generating a map with packages listed as waypoints, employees would not have to deal with databases and could simply be presented with a map having waypoints to locate the product they need to find.

Retail Setting without Direct Line of Sight

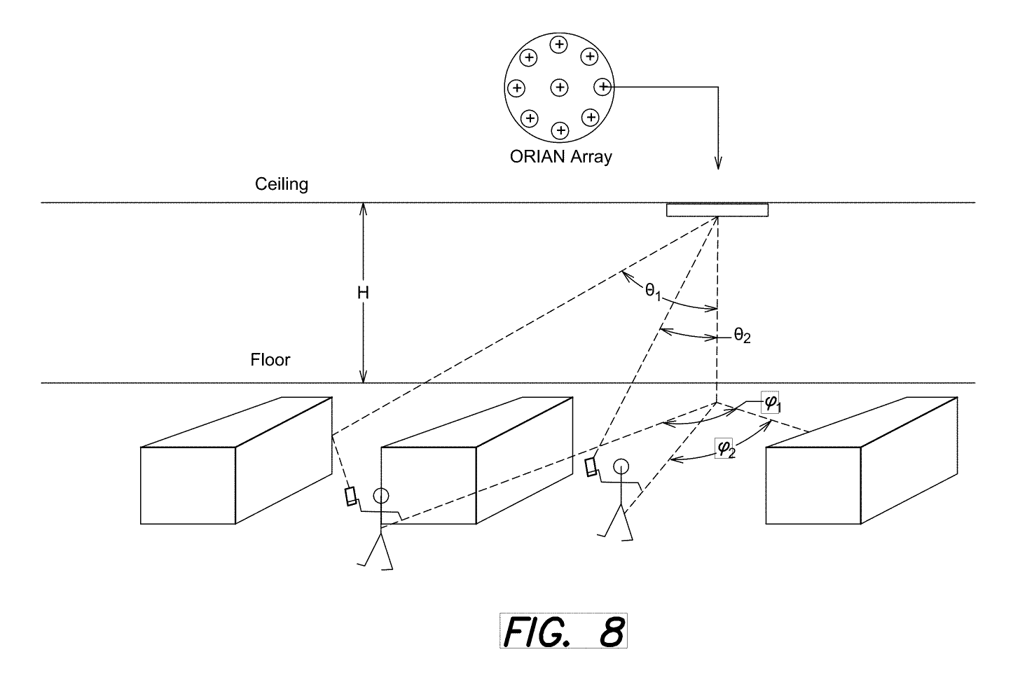

FIG. 8 illustrates a retail store such as a hardware or department store. Customers roam around the store with their smartphone and other mobile devices. Store management would benefit from being able to track the location of these devices as accurately as possible. For example, it may be desirable to determine when a customer 2 is looking at a particular shelf or other merchandise display.

To this end, one or more orientation-independent antennas are place in or near a ceiling. In an acquisition mode, the orientation-independent antenna can be controlled to scan over the entire floor with a directional, narrow beam. The beam may be relatively narrow such as 45 degrees. Individual cell phone users such as 1 and 2 are isolated and located within the beam width of the orientation-independent antenna.

Accurate elevation angle, azimuth angle and polarization of the incident plane wave are then determined using the polarization independent algorithms described in the above-referenced patent application. Since the cell phone users 1 and 2 are located on the floor, theta (θ), phi (ϕ), and H are all that are needed to determine location in three dimensions of line of sight targets such as user 2.

Targets such as user 1, which are not in a direct line of sight to the orientation-independent antenna, may be hidden by a row of shelves. The acquisition of energy by the orientation-independent antenna from target user 1 may be due to a reflection off of an adjacent line of shelves.

In one approach, with the cell phone operating a cooperative protocol that reports receive signal strength back to the orientation-independent antenna, that information for beams emitted in different directions by the orientation-independent antenna (or from different orientation-independent antennas) may resolve position ambiguities (such as by selecting the strongest received signal).

However, an estimate of the location of target 1 can also be made by using geometric ray tracing, physical optics ray tracing or using an electromagnetic modeling program such as High Frequency Electromagnetic Field Simulation (HFSS) software available from ANSYS, Inc. of Canonsburg, Pa. The high accuracy provided by the orientation-independent antenna direction of arrival algorithms enhances the result of these ray tracing methodologies. These schema typically require an accurate representation of the geometry of the store with its fixtures, walls, shelves, etc.

In some implementations, a last known position of user 2 may also be used to resolve ambiguities.

Another scheme involves calibrating the entire store by having a staff person walk through all the aisles/product locations with a cell phone, transmitting a signal to the orientation-independent antenna array. A data base of target location versus orientation-independent antenna measurement of theta and phi can then be created. Thus, for each acquisition and measurement event during store hours, there will be a corresponding unique target location.

If scattering of the target electromagnetic waves is polarization dependent (i.e. cell phone orientation), then as the calibrating person walks through the store, three orthogonal polarizations in the x,y,z directions can be generated. The data base, for each target location, will then have three components of incident plane wave information from the orientation-independent antenna, (theta, phi, polarization), for each of the three x,y,z target polarization vectors. The data base containing these three vectors for all the target locations thus calibrated can then be correlated against the received vector (theta, phi, and polarization) from the orientation-independent antenna for each acquisition and measurement event during store hours. The maximum correlation indicates which target location is valid.

The ray tracing methodologies may also take into account polarization since the orientation-independent antenna array measures the polarization of the incident wave.

What is claimed is:

1. A directional antenna apparatus comprising:
a pair of crossed dipole elements;
a loop element; and
combining circuits to produce an output proportional to at least one of azimuth or elevation of a radiated signal, the output independent of both orientation of the apparatus and polarization of the radiated signal.

2. A position detection system comprising a beacon device or tag device that use the antenna of claim 1 for reception and/or transmission of wireless signals.

3. An indoor positioning system comprising:
a beacon device for receiving a wireless signal from a tag device using an orientation independent antenna for receiving the wireless signal, the wireless signal having been transmitted from the tag device using a directional antenna.

4. A directional antenna apparatus for use within an indoor environment, comprising:
an orientation-independent antenna array located at a known height from a floor;
combining circuits to produce an output proportional to azimuth and elevation of a signal radiated from a remote device; and
a processor, for using the azimuth, elevation, and known height information to locate the remote device in three dimensions.
